(19) United States
(12) Patent Application Publication
(10) Pub. No.: US 2017/0187737 A1
(43) Pub. Date: Jun. 29, 2017

(54) Method and electronic device for processing user behavior data

(71) Applicants: Le Holdings (Beijing) Co., Ltd., Beijing (CN); LE SHI INTERNET INFORMATION&TECHNOLOGY CORP.,BEIJING, Beijing (CN)

(72) Inventor: Jiachao ZHANG, Beijing (CN)

(21) Appl. No.: 15/242,177

(22) Filed: Aug. 19, 2016

Related U.S. Application Data
(63) Continuation of application No. PCT/CN2016/088351, filed on Jul. 4, 2016.

(30) Foreign Application Priority Data
Dec. 28, 2015 (CN) 2015110014749

(51) Int. Cl. H04L 29/06

(52) U.S. Cl. CPC H04L 63/1425

(57) ABSTRACT

Disclosed are a method and an electronic device for processing user behavior data. The method includes: obtaining user behavior data, wherein the said user behavior data includes a plurality of attributes; reading the attributes of the user behavior data according to a preset dimension; where the said attributes of the user behavior data fail to match a standard rule corresponding to the preset dimension, storing the said user behavior data into a database, determining that the said user behavior data is abnormal and generating a first alarm message; where the said attributes of the user behavior data match the standard rule corresponding to the preset dimension, performing statistics analysis on the user behavior data and storing the statistics result into the database; comparing the said statistics result against a standard set corresponding to the preset dimension; and generating a second alarm message based on the comparison result.

### CROSS REFERENCE TO RELATED APPLICATIONS

The present disclosure is a continuation of PCT application which has an application number of PCT/CN2016/088351 and was filed on Jul. 4, 2016. This application is based upon and claims priority to Chinese Patent Application NO. 2015110014749, titled “method and system for processing user behavior data”, filed Dec. 28, 2015, the entire contents of both of which are incorporated herein by reference.

### TECHNICAL FIELD

The disclosure relates to the technical field of computers, and in particular to a method and an electronic device for processing user behavior data.

### BACKGROUND

With the rapid development of the Internet, the Internet has gradually become an indispensable part of people's life. People can access information that they need by browsing a website, such as searching for information, watching videos or shopping. Some traffic data and user behavior data are generated when people click or browse the website, and thus website operators can analyze a type of a customer using these data. Accuracy of final analysis results depends on reliability of the data. Therefore, sequential detection of the data is very important.

At present, website traffic data or user behavior data are collected mainly by embodying points at clients' terminals. The following factors have effects in the whole data collecting process, such as program development at the client terminal, stability of a network, stability of a server, and reliability of system architecture. Due to a huge amount of data, a problem generally cannot be found until more than one day is delayed after the problem occurs. Troubleshooting and solving the problem take time, which leads a longer period for abnormal data to exist.

### SUMMARY

In view of the above, a method and an electronic device for processing user behavior data are provided according to the disclosure, so as to solve the problem of low time-efficiency in detecting abnormal user behavior data.

In one aspect, a method for processing user behavior data is provided according to an embodiment of the disclosure which includes: obtaining user behavior data, wherein the user behavior data includes a plurality of attributes; reading the attributes of the user behavior data according to a preset dimension; where the attributes of the user behavior data fail to match a standard rule corresponding to the preset dimension, storing the user behavior data into a database, determining that the user behavior data is abnormal and generating a first alarm message; where the attributes of the user behavior data match the standard rule corresponding to the preset dimension, performing statistics analysis on the user behavior data and storing the statistics result into the database; comparing the statistics result with a standard set corresponding to the preset dimension; and generating a second alarm message based on the comparison result.

In another aspect, an electronic device, which includes:

at least one processor; and a storage device communicably connected with the said at least one processor; wherein, the said storage device stores instructions executable by the said at least one processor, the said instructions are configured for executing a method for processing user behavior data according to the disclosure.

In another aspect of an embodiment of the present disclosure, a non-transitory computer-readable storage medium, wherein the said non-transitory computer-readable storage medium can store computer-executable instructions, the said computer-executable instructions are configured for executing a method for processing user behavior data according to the disclosure.

With the method and electronic device for processing user behavior data according to embodiments of the disclosure, correctness of the user behavior data is checked and statistic data of the correct user behavior data is checked, which allows detecting abnormal data in real time, thereby solving the problem of low time-efficiency in detecting abnormal user behavior data.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 illustrates a schematic diagram of a system for processing user behavior data in accordance with an embodiment of the disclosure;

FIG. 2 illustrates a schematic diagram of a system for processing user behavior data in accordance with another embodiment of the disclosure;

FIG. 3 illustrates a flow chart of the method for processing user behavior data in accordance with an embodiment of the disclosure; and

FIG. 4 illustrates the hardware structure of the electronic device configured for executing the method for processing user behavior data according to the disclosure.

### DETAILED DESCRIPTION

The disclosure is elaborated further in detail with reference to drawings and embodiments below. Although the drawings show exemplary embodiments of the disclosure, it should be understood that the disclosure may be implemented in various forms but should not be limited to the embodiments set forth herein. On the contrary, these embodiments contribute to a more thorough understanding of the disclosure, and can completely convey the scope of the disclosure to those skilled in the art.

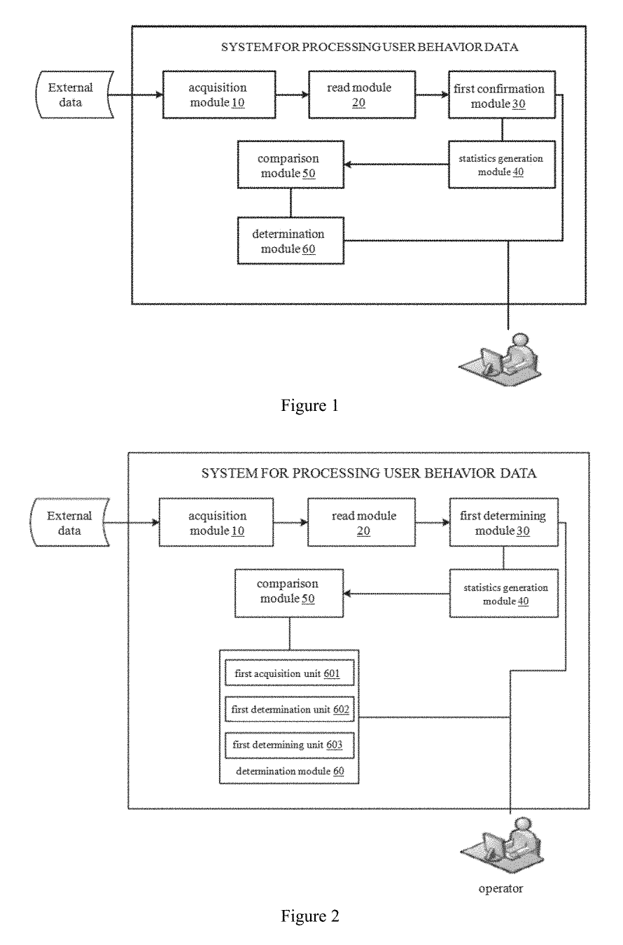

FIG. 1 shows a schematic diagram of a system for processing user behavior data in accordance with an embodiment of the disclosure. As shown in FIG. 1, the system for processing user behavior data includes: an acquisition module 10, a read module 20, a first determining module 30, a statistics generation module 40, a comparison module 50 and a determination module 60.

The acquisition module 10 obtains user behavior data which includes a plurality of attributes.

In this embodiment, some user behavior data is generated when a user accesses a website or watches a video, for example, the user's IP address, the number of user's clicks on the website or video, traffic data generated when the user accesses the website or watch the video, a browser used by the user to access the website, an APP for the user to watch the video, a search engine used by the user to search for the website or video. The user behavior data may be obtained from log files of the website. The obtaining user behavior data includes obtaining user behavior data in real time and adding the user behavior data into a message queue.

The read module 20 is configured for reading the attributes of the user behavior data according to a preset dimension.

The preset dimension(s) can be one or more, and the preset dimension(s) may be selected as needed. For example, when the duration used to play a video by the user on the website is in need of being analyzed, the duration of playing a video may be selected as the dimension. For example, when the preset dimension refers to the duration of playing a video, the duration of playing a video in the user behavior data is needed to be classified, and the duration for the user playing a video is classified into one category.

Where the attributes of the user behavior data fail to match a standard rule corresponding to the preset dimension, the first determining module 30 is configured for storing the user behavior data into a database, determining that the user behavior data is abnormal and generating a first alarm message.

In this embodiment, every time when a piece of user behavior data is received, correctness of its attributes is checked. For example, when the preset dimension refers to the duration of playing a video, the duration of playing a video in the user behavior data is needed to be detected. If the standard rule is [0,180s] and attributes of the user behavior data fail to match the standard rule, it will conclude that the user behavior data is abnormal and the first alarm message is generated to notify an associated service provider.

A statistics generation module 40 is configured for performing statistics analysis on the user behavior data and storing statistics results into a database, where the attributes of the user behavior data match the standard rule corresponding to the preset dimension.

In this embodiment, where attributes of the user behavior data match the standard rule, statistics analysis is performed on each category of data to calculate the duration of playing a video clicked by the user and the number of users for which the duration of playing a video meets the standard rule, that is, a statistics result. When the preset dimension refers to a search engine, users using different search engines are classified, counting users for each search engine and obtaining the number of search engines used and the number of times using each search engine by the users. If the preset dimension includes a plurality of dimensions, the user behavior data is calculated respectively according to the a plurality of dimensions. During every predetermined cycle, statistics analysis is performed on the user behavior data matched with the standard rule corresponding to the preset dimension, and the statistics result is stored into the database. For example, statistics analysis is performed every five minutes, and a next round of statistics analysis is performed after this round of statistics analysis is complete.

The comparison module 50 is configured for comparing the said statistics result against a standard set corresponding to the preset dimension.

In this embodiment, the standard set can be a standard used to determine whether the user behavior data is abnormal, and can be a preset standard set. When the preset dimension includes a plurality of dimensions, the standard set may also correspondingly include a plurality of standard sets, and one dimension corresponds to one standard set. For example, for video websites, dramas of different countries are popular in different degrees, and thus user click-through rates for the dramas of different countries are different. Rankings of the user click-through rates for the dramas of different countries may be obtained according to the statistics result. Generally, rankings of Korean dramas are relatively higher than others. In this case, the rankings of countries may be used as a standard set used for determining the abnormal user behavior data. For example, after the user behavior data is calculated, it is found that a user click-through rate for dramas of Hong Kong is highest, that is, the number of users clicking dramas of Hong Kong is ranked first currently. However, in the standard set corresponding to the dimension, it is found that the number of users clicking dramas of Hong Kong is ranked fifth, and the number of users clicking dramas of Hong Kong is fluctuated greatly. In this case, it can conclude that the user behavior data is abnormal at present.

In this embodiment, the standard set may be a statistics result obtained by performing statistics analysis on the user behavior data on all websites in the same field, or may also be a statistics result obtained by performing statistics analysis on historical user behavior data on the website. The statistics result is compared with the standard set. The comparison result may be a degree of deviation of the calculated result with respect to the standard set, and the degree of deviation indicates a degree of deviation between the statistics result and the standard set.

The determination module 60 is configured for generating a second alarm message based on the comparison result.

After the comparison result is obtained, it can be determined whether the user behavior data is abnormal according to the comparison result. If the statistics result is similar or identical to the standard set, it concludes that the user behavior data is normal; if the statistics result is different from the standard set, it concludes that the user behavior data is abnormal. Of course, if the statistics result is greatly different from the standard set, it concludes that the user behavior data is suspected to be abnormal, and then it determines whether a degree of deviation of the statistics result with respect to the standard set exceeds a preset threshold according to the degree of deviation.

By using the method and system for processing user behavior data according to the disclosure, correctness of the user behavior data is checked and statistic data of the correct user behavior data is also checked, to detect abnormal data in real time, thereby solving the problem of low time-efficiency in detecting abnormal user behavior data.

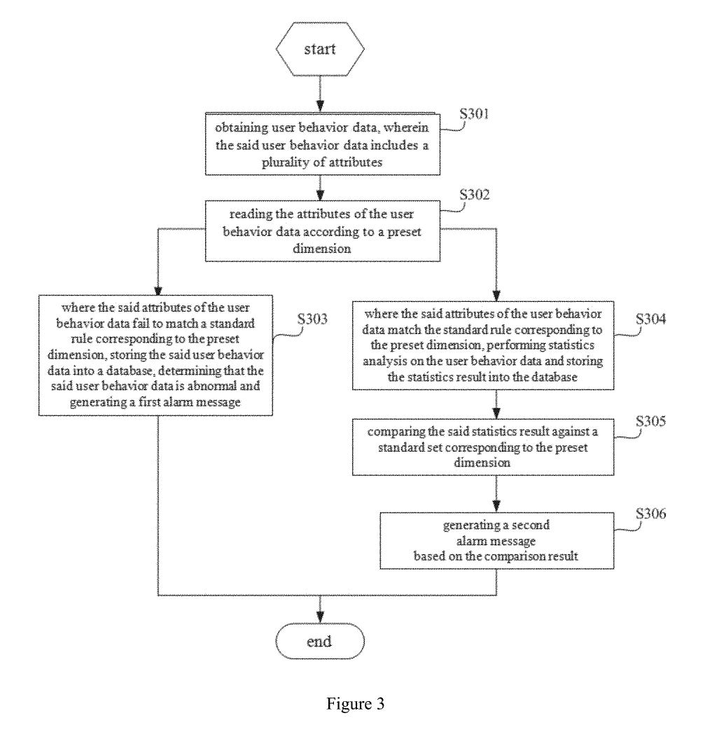

FIG. 2 shows a schematic diagram of a system for processing user behavior data in accordance with another embodiment of the disclosure. As shown in FIG. 2, the system includes: an acquisition module 10, a read module 20, a first determining module 30, a statistics generation module 40, a comparison module 50 and determination module 60. The determination module 60 comprises a first acquisition unit 601, a first determination unit 602 and a first determining unit 603. The acquisition module 10, the read module 20, the first determining module 30, the statistics generation module 40, and the comparison module 50 have the same function as the acquisition module 10, the read module 20, the first determining module 30, statistics generation module 40, and the comparison module 50 as shown in FIG. 1 respectively, which will not be repeated again herein.

The first acquisition unit 601 obtains a degree of deviation between the statistics result and the said standard set.

The degree of deviation indicates a degree of deviation between the statistics result and the standard set. A bigger value of degree of deviation indicates a greater degree of deviation between the statistics result and the standard set. For example, after the user behavior data is calculated, it is found that the number of users clicking a video is the biggest, that is, the number of users clicking the video is ranked first at present, as a statistics result. However, in the standard set corresponding to the dimension, it is found that the number of users clicking the video is ranked twentieth currently, a degree of deviation between the statistics result and the standard set is equal to 19, the degree of deviation is obtained, and then it can be determined whether the user behavior data corresponding to the statistics result is abnormal.

The first determination unit 602 is configured for determining whether the degree of deviation exceeds a preset threshold.

The preset threshold may be set in advance as needed. Preset thresholds corresponding to different dimensions may be the same or different. For example, if a preset threshold is equal to 5, the degree of deviation between the calculated result and the standard set is equal to 19 in the above example, and it can be determined whether the user behavior data is abnormal by comparing 19 with 5.

The first determining unit 603 is configured for generating a second alarm message, where the degree of deviation exceeds the preset threshold.

For example, the above example, 19>5, which indicates that the calculated result exceeds the preset threshold, and it concludes that the user behavior data is abnormal; a second alarm message is generated to notify the associated service provider.

Optionally, the preset dimension includes a first dimension and a second dimension, the obtained standard set includes a first standard set under the said first dimension and a second standard set under the said second dimension, wherein the determination module further includes: a second acquisition unit, configured for obtaining a first degree of deviation between the said statistics result and the first standard set; a third acquisition unit configured for obtaining a second degree of deviation between the said statistics result and the second standard set; a second determination unit configured for determining whether the first degree of deviation and the second degree of deviation exceed a preset threshold; and a second determining unit configured for generating a second alarm message, where both of the first degree of deviation and the second degree of deviation exceed the preset threshold.

It should be noted that the preset dimension may be three dimensions or more.

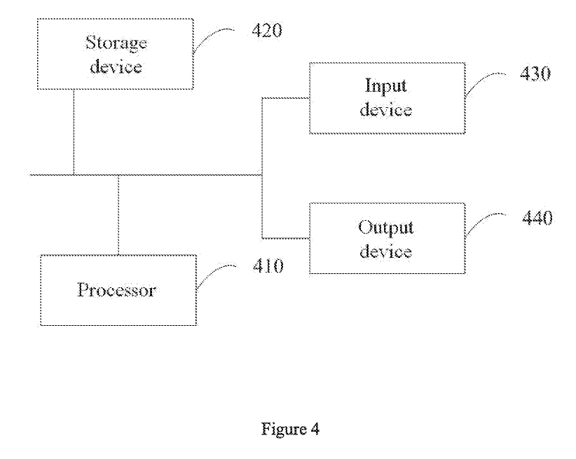

FIG. 3 shows a flow chart of method for processing user behavior data in accordance with an embodiment of the disclosure. The method for processing user behavior data includes the following steps S301 to S306.

In step S301, user behavior data is obtained, and the said user behavior data includes a plurality of attributes.

In this embodiment, some user behavior data is generated when the user accesses a website or watches a video, for example, the user's IP address, the number of the user clicking the website or video, traffic data generated when the user accesses the website or watch the video, a browser used by the user to access the website, an APP for the user watching the video, a search engine used by the user to search for the website or video. These user behavior data may be obtained from log files of the website. The obtaining user behavior data includes obtaining user behavior data in real time and adding the user behavior data into a message queue.

In step S302, the attributes of the user behavior data is read according to a preset dimension.

The preset dimension may be one or more dimensions, and the preset dimension may be selected as needed. For example, when the duration of playing a video clicked by the user on the website is needed to be analyzed, the duration of playing a video may be selected as the dimension. For example, when the preset dimension refers to the duration of playing a video, the duration of playing a video in the user behavior data is needed to be classified, and the duration for the user playing a video is classified into one category.

In step S303, the user behavior data is stored into a database, it concludes that the user behavior data is abnormal and a first alarm message is generated, where the attributes of the user behavior data fail to match a standard rule corresponding to the preset dimension.

In this embodiment, every time when a piece of user behavior data is received, correctness of its attributes is checked. For example, when the preset dimension is the duration of playing a video, the duration of playing a video in the user behavior data is needed to be detected. If the standard rule is set to be [0,180s] and the attributes of the user behavior data fail to match the standard rule, it concludes that the user behavior data is abnormal and the first alarm message is generated to notify the associated service provider.

In step S304, statistics analysis is performed on the user behavior data and the statistics result is stored into a database, when the attributes of the user behavior data match the standard rule corresponding to the preset dimension.

In this embodiment, where attributes of the user behavior data match the standard rule, statistics analysis is performed on each category of data to calculate the duration of playing a video clicked by the user and the number of users for which the duration of playing a video meets the standard rule, that is, a statistics result. When the preset dimension refers to a search engine, users using different search engines are classified, counting users for each search engine and obtaining the number of search engines used and the number of times using each search engine by the users. If the preset dimension includes a plurality of dimensions, the user behavior data is calculated respectively according to the a plurality of dimensions. During every predetermined cycle, statistics analysis is performed on the user behavior data matched with the standard rule corresponding to the preset dimension, and the statistics result is stored into the database. For example, statistics analysis is performed every five minutes, and a next round of statistics analysis is performed after this round of statistics analysis is complete.

In step S305, the statistics result is compared against a standard set corresponding to the preset dimension.

In this embodiment, the standard set can be a standard used to determine whether the user behavior data is abnormal, and can be a preset standard set. When the preset dimension includes a plurality of dimensions, the standard set may also correspondingly include a plurality of standard sets, and one dimension corresponds to one standard set. For example, for video websites, dramas of different countries are popular in different degrees, and thus user click-through rates for the dramas of different countries are different. Rankings of the user click-through rates for the dramas of different countries may be obtained according to the statistics result. Generally, rankings of Korean dramas are relatively higher than others. In this case, the rankings of countries may be used as a standard set used for determining the abnormal user behavior data. For example, after the user behavior data is calculated, it is found that a user click-through rate for dramas of Hong Kong is highest, that is, the number of users clicking dramas of Hong Kong is ranked first currently. However, in the standard set corresponding to the dimension, it is found that the number of users clicking dramas of Hong Kong is ranked fifth, and the number of users clicking dramas of Hong Kong is fluctuated greatly. In this case, it can conclude that the user behavior data is abnormal at present.

In this embodiment, the standard set may be a statistics result obtained by performing statistics analysis on the user behavior data on all websites in the same field, or may also be a statistics result obtained by performing statistics analysis on historical user behavior data on the website. The statistics result is compared with the standard set. The comparison result may be a degree of deviation of the calculated result with respect to the standard set, and the degree of deviation indicates a degree of deviation between the statistics result and the standard set.

In step S306, a second alarm message is generated based on the comparison result.

After the comparison result is obtained, it can be determined whether the user behavior data is abnormal according to the comparison result. If the statistics result is similar or identical to the standard set, it concludes that the user behavior data is normal; if the statistics result is different from the standard set, it concludes that the user behavior data is abnormal. Of course, if the statistics result is greatly different from the standard set, it concludes that the user behavior data is suspected to be abnormal, and then it is determined whether a degree of deviation of the statistics result with respect to the standard set exceeds a preset threshold according to the degree of deviation.

With the method and system for processing user behavior data according to the disclosure, correctness of the user behavior data is checked and statistic data of the correct user behavior data is also checked, to detect abnormal data in real time, thereby solving the problem of low time-efficiency in detecting abnormal user behavior data.

A non-transitory computer-readable storage medium, wherein the said non-transitory computer-readable storage medium can store computer-executable instructions, and the said instructions are configured to execute part or all of the steps in each of implementations of the method for processing user behavior data according to the disclosure.

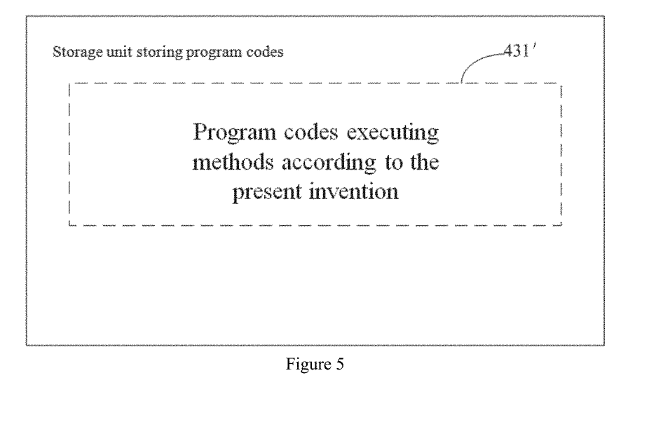

FIG. 4 illustrates the hardware structure of the electronic device configured for executing the method for processing user behavior data according to the disclosure. As shown in FIG. 4, the said electronic device comprises:

one processor 410, which is shown in FIG. 4 as an example, or more processors and a storage device 420;

the electronic device executing the method for processing user behavior data further comprises: an input device 430 and an output device 440;

processor 410, storage device 420, input device 430 and output device 440 can be connected by BUS or other methods, and BUS connecting is showed in FIG. 4 as an example.

Storage device 420 can be used for storing non-transitory software program, non-transitory computer executable program and modules as a non-transitory computer-readable storage medium, such as corresponding program instructions/modules for executing the methods for processing user behavior data mentioned by embodiments of the present disclosure (for example, as shown in FIG. 1, an acquisition module 10, a read module 20, a first determining module 30, a statistics generation module 40, a comparison module 50 and a determination module 60). Processor 410 by executing non-transitory software program performs all kinds of functions of a server and process data, instructions and modules which are stored in storage device 420, thereby realizes the methods for processing user behavior data mentioned by embodiments of the present disclosure.

Storage device 420 can include program storage area and data storage area, thereby the operating system and applications required by at least one function can be stored in program storage area and data created by using the device for controlling standby power consumption of a mobile terminal can be stored in data storage area. Furthermore, storage device 420 can include high speed Random-access memory (RAM) or non-volatile memory such as hard drive storage device, flash memory device or other non-volatile solid state storage devices. In some embodiments, storage device 420 can include long-distance setup memories relative to processor 410, which can communicate via network with the device for realizing the methods mentioned by embodiments of the present disclosure. The examples of said networks are including but not limited to Internet, Intranet, LAN, mobile Internet and their combinations.

Input device 430 can be used to receive inputted number, character information and key signals causing user configures and function controls of the device. Output device 440 can include a display screen or a display device.

The said module or modules are stored in storage device 420 and perform any one of the methods for processing user behavior data when executed by one or more processors 410.

The said device can achieve the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a hard drive, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-8. (canceled)

9. A method, applied to an electronic device, for processing user behavior data, comprising:
obtaining user behavior data, wherein the said user behavior data includes a plurality of attributes;
reading the attributes of the user behavior data according to a preset dimension;
where the said attributes of the user behavior data fail to match a standard rule corresponding to the preset dimension, storing the said user behavior data into a database, determining that the said user behavior data is abnormal and generating a first alarm message;
where the said attributes of the user behavior data match the standard rule corresponding to the preset dimension, performing statistics analysis on the user behavior data and storing the statistics result into the database;
comparing the said statistics result against a standard set corresponding to the preset dimension; and
generating a second alarm message based on the comparison result.

10. The method according to claim 9, wherein the obtaining user behavior data comprises:
receiving pushed user behavior data; and
adding the said user behavior data into a message queue.

11. The method according to claim 10, wherein, where the said attributes of the user behavior data match the standard rule corresponding to the preset dimension, performing statistics analysis on the user behavior data and storing the statistics result into the database, comprising:
during every preset time cycle, performing statistics analysis on the user behavior data which matches to the standard rule corresponding to the preset dimension, and storing the statistics result into the database.

12. The method according to claim 10, wherein, the generating a second alarm message based on the comparison result comprising:
obtaining the degree of deviation between the said statistics result and the said standard set;
determining whether the said degree of deviation exceeds a preset threshold; and
generating a second alarm message if the said degree of deviation exceeds the preset threshold.

13. The method according to claim 10, wherein the said preset dimension comprises a first dimension and a second dimension, the obtained standard set comprises a first standard set under the said first dimension and a second standard set under the said second dimension, wherein the generating a second alarm message based on the comparison result comprises:
obtaining a first degree of deviation between the said statistics result and the first standard set;
obtaining a second degree of deviation between the said statistics result and the second standard set;
determining whether the said first degree of deviation and the said second degree of deviation exceed the preset threshold; and
generating a second alarm message if both of the said first degree of deviation and the said second degree of deviation exceed the said preset threshold.

14. An electronic device, comprising:
at least one processor; and
a storage device communicably connected with the said at least one processor; wherein,
the said storage device stores instructions executable by the said at least one processor, wherein execution of the instructions by the said at least one processor causes the at least one processor to:
obtain user behavior data, wherein the said user behavior data includes a plurality of attributes;
read the attributes of the user behavior data according to a preset dimension;
where the said attributes of the user behavior data fail to match a standard rule corresponding to the preset dimension, store the said user behavior data into a database, determine that the said user behavior data is abnormal and generate a first alarm message;
where the said attributes of the user behavior data match the standard rule corresponding to the preset dimension, perform statistics analysis on the user behavior data and store the statistics result into the database;
compare the said statistics result against a standard set corresponding to the preset dimension; and
generate a second alarm message based on the comparison result.

15. The electronic device according to claim 14, wherein the execution of the instructions to obtain user behavior data causes the at least one processor to:
receive pushed user behavior data; and
add the said user behavior data into a message queue.

16. The electronic device according to claim 15, wherein the execution of the instructions to where the said attributes of the user behavior data match the standard rule corresponding to the preset dimension, performing statistics analysis on the user behavior data and storing the statistics result into the database causes the at least one processor to:
during every preset time cycle, perform statistics analysis on the user behavior data which matches to the standard rule corresponding to the preset dimension, and store the statistics result into the database.

17. The electronic device according to claim 15, wherein the execution of the instructions to generate a second alarm message based on the comparison result causes the at least one processor to:
obtain a degree of deviation between the statistics result and the standard set;
determine whether the degree of deviation exceeds a preset threshold; and
generate the second alarm message, where the degree of deviation exceeds the preset threshold.

18. The electronic device according to claim 15, wherein the preset dimension comprises a first dimension and a second dimension, the obtained standard set comprises a first standard set under the first dimension and a second standard set under the second dimension, wherein the execution of the instructions to generate a second alarm message based on the comparison result causes the at least one processor to:
obtain a first degree of deviation between the said statistics result and the first standard set;
obtain a second degree of deviation between the said statistics result and the second standard set;
determine whether the said first degree of deviation and the said second degree of deviation exceed the preset threshold; and
generate a second alarm message if both of the said first degree of deviation and the said second degree of deviation exceed the said preset threshold.

19. A non-transitory computer-readable storage medium, wherein the said non-transitory computer-readable storage medium store computer-executable instructions that, when executed by an electronic device, cause the electronic device to:
obtain user behavior data, wherein the said user behavior data includes a plurality of attributes;
read the attributes of the user behavior data according to a preset dimension;
where the said attributes of the user behavior data fail to match a standard rule corresponding to the preset dimension, store the said user behavior data into a database, determine that the said user behavior data is abnormal and generate a first alarm message;
where the said attributes of the user behavior data match the standard rule corresponding to the preset dimension, perform statistics analysis on the user behavior data and store the statistics result into the database;
compare the said statistics result against a standard set corresponding to the preset dimension; and
generate a second alarm message based on the comparison result.

20. The non-transitory computer-readable storage medium according to claim 19, wherein the instructions to obtain user behavior data cause the electronic device to:
receive pushed user behavior data; and
add the said user behavior data into a message queue.

21. The non-transitory computer-readable storage medium according to claim 20, wherein the instructions to where the said attributes of the user behavior data match the standard rule corresponding to the preset dimension, performing statistics analysis on the user behavior data and storing the statistics result into the database to:
during every preset time cycle, perform statistics analysis on the user behavior data which matches to the standard rule corresponding to the preset dimension, and store the statistics result into the database.

22. The non-transitory computer-readable storage medium according to claim 20, wherein the instructions to generate a second alarm message based on the comparison result cause the electronic device to:
obtain the degree of deviation between the said statistics result and the said standard set;
determine whether the said degree of deviation exceeds a preset threshold; and
generate a second alarm message if the said degree of deviation exceeds the preset threshold.

23. The non-transitory computer-readable storage medium according to claim 20, wherein the said preset dimension comprises a first dimension and a second dimension, the obtained standard set comprises a first standard set under the said first dimension and a second standard set under the said second dimension, wherein the instructions to generate a second alarm message based on the comparison result cause the electronic device to:
obtain a first degree of deviation between the said statistics result and the first standard set;
obtain a second degree of deviation between the said statistics result and the second standard set;
determine whether the said first degree of deviation and the said second degree of deviation exceed the preset threshold; and
generate a second alarm message if both of the said first degree of deviation and the said second degree of deviation exceed the said preset threshold.
